(19) United States
(12) Patent Application Publication
(10) Pub. No.: US 2026/0211494 A1
(43) Pub. Date: Jul. 23, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Rui KONDO, Tokyo (JP); Yasuhiko YOSHIDA, Tokyo (JP); Kazuma KUNIYOSHI, Tokyo (JP); Shinnosuke NISHIMOTO, Tokyo (JP)

(73) Assignee: NEC Corporation, Tokyo (JP)

(21) Appl. No.: 19/427,034

(22) Filed: Dec. 19, 2025

(30) Foreign Application Priority Data
Jan. 20, 2025 (JP) 2025-007699

(51) Int. Cl. G06F 3/01

(52) U.S. Cl. CPC G06F 3/013

(57) ABSTRACT

An information processing device of the present disclosure includes an acquisition unit, a detection unit, and a display unit. The acquisition unit acquires a line-of-sight history of a user in a virtual space. The detection unit detects, as a target area, an area in which a degree of concentration of lines of sight of the users satisfies a selection condition based on the line-of-sight history. The display unit displays the presentation information in the target area.

This application is based upon and claims the benefit of priority from Japanese patent application No. 2025-7699, filed on Jan. 20, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

A technology related to this disclosure is disclosed in WO 2023/063124 A1. WO 2023/063124 A1 discloses a technology for evaluating a value of “an area for presenting information such as an advertisement” in a virtual space. In the technology, the number of people for each time zone in each area is obtained, and the value of each area is evaluated based on this value. The value of an area that can be seen from an area with a larger population is increased.

### SUMMARY

In recent years, the number of users active in a virtual space is increasing. An object of this disclosure is to develop a technology related to information presentation to a user via a virtual space.

According to one aspect of the present disclosure,
there is provided an information processing device including
an acquisition means for acquiring a line-of-sight history of a user in a virtual space,
a detection means for detecting, as a target area, an area in which a degree of concentration of lines of sight of users satisfies a selection condition based on the line-of-sight history, and
a display means for displaying presentation information in the target area.

According to one aspect of the present disclosure,
there is provided an information processing method for causing one or more computers to execute
acquiring a line-of-sight history of a user in a virtual space,
detecting, as a target area, an area in which a degree of concentration of lines of sight of users satisfies a selection condition based on the line-of-sight history, and
displaying presentation information in the target area.

According to one aspect of the present disclosure,
there is provided a program for causing a computer to execute processing including
acquiring a line-of-sight history of a user in a virtual space,
detecting, as a target area, an area in which a degree of concentration of lines of sight of users satisfies a selection condition based on the line-of-sight history, and
displaying presentation information in the target area.

According to an example of this disclosure, it is possible to develop a technology related to information presentation to a user via a virtual space.

### BRIEF DESCRIPTION OF THE DRAWINGS

FIG. 1 is a diagram illustrating an example of a functional block diagram of an information processing device;

FIG. 2 is a flowchart illustrating an example of a flow of processing of the information processing device;

FIG. 3 is a diagram illustrating an example of a hardware configuration of the information processing device;

FIG. 4 is a diagram illustrating an example of a screen displayed on a terminal device of a user;

FIG. 5 is a diagram illustrating another example of the screen displayed on the terminal device of the user;

FIG. 6 is a diagram illustrating another example of the screen displayed on the terminal device of the user;

FIG. 7 is a diagram illustrating an example of a functional block diagram of an information processing device;

FIG. 8 is a diagram illustrating another example of the screen displayed on the terminal device of the user;

FIG. 9 is a diagram illustrating another example of a functional block diagram of the information processing device; and

FIG. 10 is a diagram illustrating another example of the screen displayed on the terminal device of the user.

### EXAMPLE EMBODIMENT

Hereinafter, an example embodiment of the present disclosure will be described with reference to the drawings. In this disclosure, the drawings are associated with one or more example embodiments. In all the drawings, the same components are denoted by the same reference signs, and description thereof will be omitted as appropriate.

### First Example Embodiment

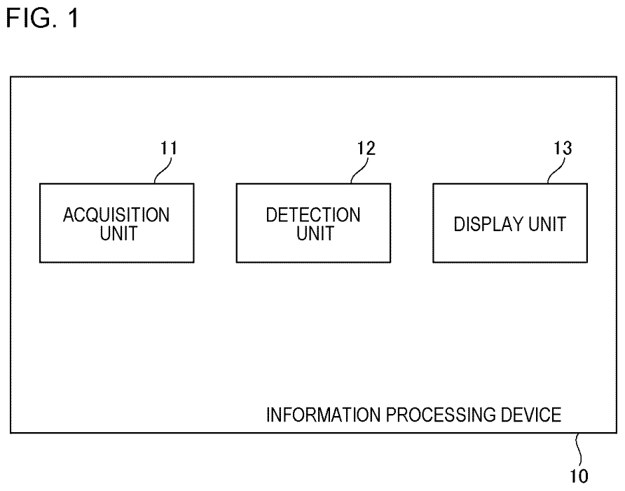

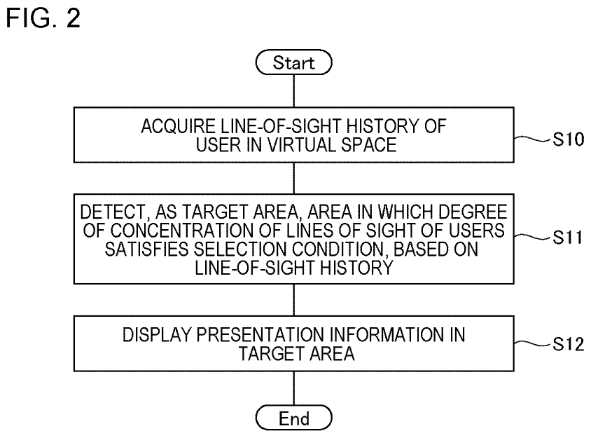

FIG. 1 is a functional block diagram illustrating an outline of an information processing device 10. FIG. 2 is a flowchart illustrating an example of a flow of processing executed by the information processing device 10.

As illustrated in FIG. 1, the information processing device 10 includes an acquisition unit 11, a detection unit 12, and a display unit 13. The processing illustrated in the flowchart of FIG. 2 is executed by these functional units.

In S10, the acquisition unit 11 acquires the line-of-sight history of the user in the virtual space.

In S11, the detection unit 12 detects, as a target area, an area in which the degree of concentration of the lines of sight of the users satisfies the selection condition based on the line-of-sight history of the user.

In S12, the display unit 13 displays the presentation information in the target area.

Meanwhile, there is a technology of presenting information such as an advertisement to a user via a virtual space. In recent years, the number of users active in a virtual space is increasing. Therefore, by presenting information to the user via the virtual space, it is possible to effectively convey information to many users. However, the virtual space has a certain extent. A large number of various objects exist in the virtual space. Therefore, in a case where information is simply displayed in the virtual space, there is a possibility that the information is overlooked without being noticed by the user.

The information processing device 10 is configured to be able to solve such a problem regarding information presentation to the user via the virtual space. As described above, the information processing device 10 detects, as a target area, an area in which the degree of concentration of the lines of sight of the users satisfies the selection condition in the virtual space. Then, the information processing device 10 displays information in the detected target area.

According to such an information processing device 10, by appropriately setting the selection condition, for example, information can be displayed in a target area where the lines of sight of more users is concentrated. As a result, more users can view the information displayed in the virtual space. According to such an information processing device 10, it is possible to more efficiently convey information to more users in information presentation to the users via the virtual space.

### Second Example Embodiment

### Overview

An information processing device 10 of a second example embodiment is obtained by embodying the configuration of the information processing device 10 of the first example embodiment. Details will be described below.

### Hardware Configuration

First, an example of a hardware configuration of the information processing device 10 will be described. Each functional unit of the information processing device 10 is achieved by any combination of hardware and software. It is to be understood by those skilled in the art that there are various modification examples of the implementation method and the device. The software includes a program stored in advance from a stage of shipping the device, a program downloaded from a recording medium such as a Compact Disc (CD), a server on the Internet, or the like.

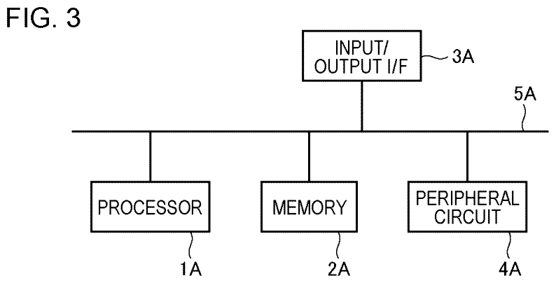

FIG. 3 is a block diagram illustrating a hardware configuration of the information processing device 10. As illustrated in FIG. 3, the information processing device 10 includes a processor 1A, a memory 2A, an input/output interface 3A, a peripheral circuit 4A, and a bus 5A. The peripheral circuit 4A includes various modules. The information processing device 10 does not necessarily include the peripheral circuit 4A. The information processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing device such as a central processing unit (CPU) or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like, and an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a projection device, a speaker, a printer, a mailer, or the like. The processor 1A can issue commands to the modules and execute calculation based on calculation results by the modules.

### Functional Configuration

Next, a functional configuration of the information processing device 10 will be described in detail. FIG. 1 is an example of a functional block diagram of the information processing device 10. As illustrated, the information processing device 10 includes an acquisition unit 11, a detection unit 12, and a display unit 13.

The acquisition unit 11 acquires a line-of-sight history of the user in the virtual space. The acquisition unit 11 can acquire the line-of-sight history of each of a plurality of users. The acquisition unit 11 may acquire the line-of-sight history of each of a plurality of users in association with identification information of each user.

The “virtual space” is a virtual space constructed on a computer or a network. The virtual space may be a space composed of elements different from those in the real world. In addition, the virtual space may be a space in which the real world is reproduced, that is, a space configured by elements similar to those in the real world. Reproduction of the real world can be implemented by a technology such as a digital twin.

In the virtual space, there are a plurality of characters. The character is called an avatar. The user can operate/control his/her own character existing in the virtual space, interact with other users, and have various experiences. In the virtual space, there may be a non-player character controlled by a computer. The non-player character can move in the virtual space or interact with other characters according to the control of the computer. Such a virtual space is known as, for example, a metaverse. The virtual space is created using, for example, various technologies related to the metaverse.

The “user” operates/controls his/her own character existing in the virtual space to interact with other users and to have various experiences.

The user operates his/her terminal device to log in to a server (for example, the information processing device 10) that provides the virtual space. Then, the user operates his/her own character while viewing the virtual space displayed on the terminal device. Examples of the terminal device include, but are not limited to, a personal computer, a smartphone, a tablet terminal, a game machine, a headset, and other wearable terminals.

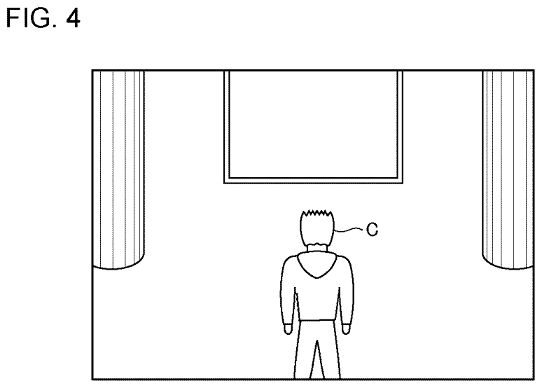

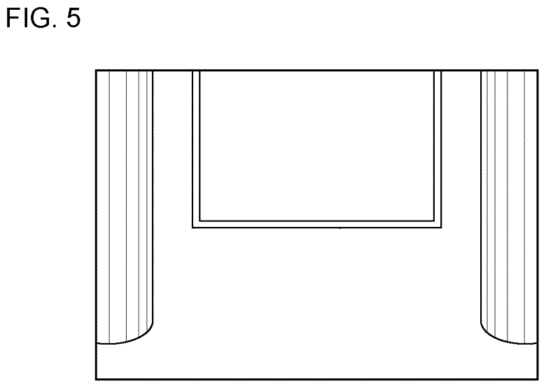

The server may display a screen of a third-person viewpoint as illustrated in FIG. 4, or may display a screen of a first-person viewpoint as illustrated in FIG. 5. The user may be able to switch between the two screen displays. As illustrated in FIG. 4, the screen of the third-person viewpoint illustrates a state in which the virtual space is viewed from the third-person viewpoint through a character C operated by the user. As illustrated in FIG. 5, the screen of the first-person viewpoint illustrates a state in which the virtual space is viewed from the viewpoint of the character C operated by the user.

The “line-of-sight history of the user in the virtual space” indicates a history of an area in the virtual space to which the line of sight of the user is directed. The line-of-sight history of the user can be rephrased as a history of areas in the virtual space that the user is looking at or is assumed to be looking at.

The “area in the virtual space” is a closed partial space in the three-dimensional virtual space. For example, a three-dimensional virtual space may be decomposed into voxels. Then, an area in the virtual space may be indicated by a set of one or more voxels. One voxel may be treated as one area. In addition, a set of a plurality of voxels may be treated as one area. In a case where a set of a plurality of voxels is treated as one area, the shape and size of each area are standardized in advance, and the shape and size of all the areas may be common. In addition, in a case where a set of a plurality of voxels is treated as one area, the shape and size of each area are not standardized in advance, and the shapes and sizes of the plurality of areas may be different from each other.

The line-of-sight history of the user may indicate an area in the virtual space to which the line of sight of the user is currently directed. The line-of-sight history of the user can indicate an area in the virtual space to which the line of sight of the user is directed at each of a plurality of past timings. The timing can be a timing at predetermined time intervals, but is not limited thereto.

The acquisition unit 11 can generate a line-of-sight history of each user based on any one of the following first to fourth acquisition examples.

### First Acquisition Example

In this example, the acquisition unit 11 can generate a line-of-sight history indicating an area in the virtual space displayed on the screen for the user as an area to which the line of sight of the user is directed.

In this example, the acquisition unit 11 can generate a line-of-sight history indicating an area in the virtual space displayed on the screen for the user as illustrated in FIGS. 4 and 5 as an area to which the line of sight of the user is directed.

### Second Acquisition Example

In this example, the acquisition unit 11 can generate a line-of-sight history indicating a part of an area in the virtual space displayed on the screen for the user as an area to which the line of sight of the user is directed.

In this example, the acquisition unit 11 can generate a line-of-sight history indicating a part of the area in the virtual space displayed on the screen for the user as illustrated in FIGS. 4 and 5 as an area to which the line of sight of the user is directed.

In one example, the acquisition unit 11 can generate a line-of-sight history indicating a part near the center of the screen for the user as an area to which the line of sight of the user is directed. Usually, it is considered that the user views the vicinity of the center of the screen. Based on such a tendency, the acquisition unit 11 may generate a line-of-sight history indicating a part near the center of the screen for the user as an area to which the line of sight of the user is directed. In this example, a part near the center of the screen for the user is defined in advance as an area to which the line of sight of the user is directed. For example, a circular area within the distance r from the center of the screen for the user may be defined as an area to which the line of sight of the user is directed, or may be defined by other methods.

As another example, the acquisition unit 11 may specify which part of the screen the user is viewing by using a technology of detecting and tracking the line of sight of the user. Then, the acquisition unit 11 may specify a part of the specified screen as an area to which the line of sight of the user is directed. For example, the acquisition unit 11 may divide the screen for the user into a plurality of in-screen areas according to a predetermined rule, and specify which in-screen area the user is viewing based on the line of sight of the user. The acquisition unit 11 can detect the line of sight of the user by acquiring an image obtained by photographing the face of the user from, for example, a terminal device of the user and analyzing the image. Since a technology for implementing the detection of the line of sight of the user is widely known, the description thereof will be omitted here.

### Third Acquisition Example

In this example, similarly to the first acquisition example, the acquisition unit 11 can generate a line-of-sight history indicating an area in the virtual space displayed on the screen for the user as an area to which the line of sight of the user is directed. Then, the acquisition unit 11 can classify the area in the virtual space displayed on the screen for the user into “the area at which the user is gazing” and “the area in the user's field of view”, and generate the line-of-sight history further indicating the classification result.

For example, the acquisition unit 11 can specify a part of the area in the virtual space displayed on the screen for the user as “the area at which the user is gazing”. Then, the acquisition unit 11 can specify the other portion of the area in the virtual space displayed on the screen for the user as “an area in the user's field of view”.

The acquisition unit 11 may specify a part near the center of the screen for the user as an area at which the user is gazing. In addition, the acquisition unit 11 may specify which part of the screen the user is viewing by using a technology of detecting and tracking the line of sight of the user. Then, the acquisition unit 11 may specify a part of the specified screen as an area at which the user is gazing. Details of these methods are as described in the above-described second acquisition example.

### Fourth Acquisition Example

In this example, the acquisition unit 11 can generate a line-of-sight history indicating an area in the virtual space existing in a direction in which the face of the character operated by the user is directed as an area in which the line of sight of the user is directed.

For example, the acquisition unit 11 analyzes the state of the character operated by the user, and specifies the direction in which the face of the character is directed. Then, the acquisition unit 11 generates a two-dimensional image illustrating a state observed in a case where the inside of the virtual space is viewed from the character operated by the user toward the specified direction. The two-dimensional image is an image similar to the screen of the first-person viewpoint illustrating a state of looking at the virtual space from the viewpoint of the character C operated by the user as illustrated in FIG. 5. The contour shape of the two-dimensional image may be rectangular, circular, or any other shape. Then, the acquisition unit 11 can generate the line-of-sight history using the two-dimensional image instead of the “screen for user” in the first to third acquisition examples.

Returning to FIG. 1, the detection unit 12 detects, as a target area, an area in which the degree of concentration of the lines of sight of the users satisfies the selection condition based on the line-of-sight history of the user in the virtual space.

The “degree of concentration of the lines of sight of the users on each area” indicates at least one of the following.
Degree of concentration of lines of sight of users on each area at present time
Degree of concentration of lines of sight of users on each area in past predetermined period
Degree of concentration of lines of sight of users on each area in past predetermined period

The “degree of concentration of the lines of sight of users on each area at the present time” indicates how many users actually gather their line of sight in each area at the present time, that is, how many users are viewing each area.

For example, the above-described acquisition unit 11 acquires the line-of-sight history of each of the plurality of users in real time, and inputs the line-of-sight history to the detection unit 12. The detection unit 12 specifies an area to which the line of sight of each of the plurality of users is directed at the present time based on the latest line-of-sight history of each of the plurality of users. Then, the detection unit 12 can calculate the number of users viewing each of the plurality of areas in the virtual space in real time by statistically processing the result.

In the third acquisition example described above, the “area at which the user is gazing” and the “area in the user's field of view” are specified. In this case, the detection unit 12 may calculate the number of users viewing each of the plurality of areas in the virtual space according to the following counting rule.
“Area at which one user is gazing” is counted as “area viewed by one user”.
“Area in one user's field of view” is counted as “area viewed by C users”. “C” is a value in a range of greater than 0 and less than 1, and is determined in advance.

The “degree of concentration of the lines of sight of users on each area in a past predetermined period” indicates how many users actually gathered their line of sight on each area, that is, how many users viewed each area in a past predetermined period.

For example, the above-described acquisition unit 11 inputs the line-of-sight history of each of the plurality of users in a past predetermined period to the detection unit 12. Based on the line-of-sight history, the detection unit 12 specifies users who have gazed at each area in a past predetermined period, that is, users who have viewed each area, and counts the number of users. In this example, the number of users who have gazed at each area in a past predetermined period is the degree of concentration of the lines of sight of users on each area in a past predetermined period. The past predetermined period is determined in advance. The past predetermined period may be, for example, the latest past one year, the latest past six months, the past several minutes, or the like.

In the third acquisition example described above, the “area at which the user is gazing” and the “area in the user's field of view” are specified. In this case, the detection unit 12 may calculate the number of users who have viewed each of the plurality of areas in the virtual space according to the counting rule described above.

The “degree of concentration of the lines of sight of users on each area in a past predetermined period” indicates the degree of concentration of the lines of sight of users on each area. The degree of concentration of the lines of sight of users on each area in a past predetermined period indicates the degree to which the line of sight of each user has actually gathered on each area in a past predetermined period, that is, how much each user has viewed each area.

For example, the above-described acquisition unit 11 inputs the line-of-sight history of each of the plurality of users in a past predetermined period to the detection unit 12. The detection unit 12 can process the line-of-sight history for each user and calculate at least one of the number of times each user has looked at each area in the virtual space, the cumulative time of looking at each area, and the duration of time of continuously looking at each area. In this example, at least one of the number of times each user has looked at each area in the virtual space in a past predetermined period, the cumulative time of looking at each area, and the duration of time of continuously looking at each area is the degree of concentration of the lines of sight of users on each area in a past predetermined period.

The detection unit 12 detects, as a target area, an area in which the degree of concentration of the lines of sight of the users calculated as described above satisfies the selection condition.

In the “selection condition”, the degree of concentration of the lines of sight of the users is equal to or higher than a reference level. The reference level is predetermined. With such a selection condition, it is possible to detect, as a target area, an area where the degree of concentration of the lines of sight of the users is equal to or higher than the reference level, that is, an area where the line of sight of the user is frequently concentrated.

As described above, the degree of concentration of the lines of sight of the users on each area can include various concepts. Then, the content of the selection condition is optimized for each concept. Hereinafter, an example of details of the selection condition according to the content of the degree of concentration of the lines of sight of the users on each area will be described.

### Case Where the Degree of Concentration of Lines of Sight of Users on Each Area Indicates the Degree of Concentration of Lines of Sight of Users on Each Area at the Present Time

An example of the selection condition in this case is “an area viewed by the number of users equal to or greater than the threshold at the present time”. In one example, the detection unit 12 can detect one or a plurality of areas satisfying such a selection condition as a target area. The threshold is a value determined in advance.

Another example of the selection condition in this case is “an area that is viewed by the most users at the present time”. In one example, the detection unit 12 can detect one area satisfying such a selection condition as a target area.

Another example of the selection condition in this case is “an area ranked in the top P in ranking in descending order of the number of users viewing at the present time”. In one example, the detection unit 12 can detect a plurality of areas satisfying such a selection condition as target areas. P is predetermined.

Another example of the selection condition in this case is “an area in the top Q% in ranking in descending order of the number of users viewing at the present time”. In one example, the detection unit 12 can detect a plurality of areas satisfying such a selection condition as target areas. Q is predetermined.

### Case Where the Degree of Concentration of Lines of Sight of Users on Each Area Indicates the Degree of Concentration of Lines of Sight of Users on Each Area in a Past Predetermined Period

An example of the selection condition in this case is “an area in which the number of users who have gazed at in a past predetermined period is equal to or larger than a threshold”. In one example, the detection unit 12 can detect one or a plurality of areas satisfying such a selection condition as a target area. The threshold is a value determined in advance.

Another example of the selection condition in this case is “an area having the largest number of users who have gazed at in a past predetermined period”. In one example, the detection unit 12 can detect one area satisfying such a selection condition as a target area.

Another example of the selection condition in this case is “an area included in the top P in ranking in descending order of the number of users who have gazed at in a past predetermined period”. In one example, the detection unit 12 can detect a plurality of areas satisfying such a selection condition as target areas. P is predetermined.

Another example of the selection condition in this case is “an area included in the top Q% in ranking in descending order of the number of users who have gazed at in a past predetermined period”. In one example, the detection unit 12 can detect a plurality of areas satisfying such a selection condition as target areas. Q is predetermined.

### Case Where the Degree of Concentration of Lines of Sight of Users on Each Area Indicates the Degree of Concentration of Lines of Sight of Users on Each Area in a Past Predetermined Period

In this example, the detection unit 12 can detect the target area for each user.

An example of the selection condition in this case is “an area in which the number of times each user has gazed at in a past predetermined period is equal to or greater than a threshold”. In one example, the detection unit 12 can detect one or a plurality of areas satisfying such a selection condition as a target area for each user. The threshold is a value determined in advance.

Another example of the selection condition in this case is “an area in which the cumulative time during which each user has gazed at in a past predetermined period is equal to or greater than a threshold”. In one example, the detection unit 12 can detect one or a plurality of areas satisfying such a selection condition as a target area for each user. The threshold is a value determined in advance.

Another example of the selection condition in this case is “an area in which the duration of time during which each user has kept gazing at the area in a past predetermined period is equal to or greater than the threshold”. In one example, the detection unit 12 can detect one or a plurality of areas satisfying such a selection condition as a target area for each user. The threshold is a value determined in advance.

Another example of the selection condition in this case is “an area in which the number of times each user has gazed at the area is the largest number in a past predetermined period”. In one example, the detection unit 12 can detect one area satisfying such a selection condition as a target area for each user.

Another example of the selection condition in this case is “an area having the largest cumulative time during which each user has gazed at the area in a past predetermined period”. In one example, the detection unit 12 can detect one area satisfying such a selection condition as a target area for each user.

Another example of the selection condition in this case is “an area having the largest duration in which each user has kept gazing at the area in a past predetermined period”. In one example, the detection unit 12 can detect one area satisfying such a selection condition as a target area for each user.

Another example of the selection condition in this case is “an area included in the top P in ranking in descending order of the number of times each user has gazed at the area in a past predetermined period”. In one example, the detection unit 12 can detect a plurality of areas satisfying such a selection condition as a target area for each user. P is predetermined.

Another example of the selection condition in this case is “an area included in the top Q% in ranking in descending order of the number of times each user has gazed at the area in a past predetermined period”. In one example, the detection unit 12 can detect a plurality of areas satisfying such a selection condition as a target area for each user. Q is predetermined.

Another example of the selection condition in this case is “an area included in the top P in ranking in descending order of the cumulative time in which each user has gazed at the area in a past predetermined period”. In one example, the detection unit 12 can detect a plurality of areas satisfying such a selection condition as a target area for each user. P is predetermined.

Another example of the selection condition in this case is “an area included in the top Q% in ranking in descending order of the cumulative time in which each user has gazed at the area in a past predetermined period”. In one example, the detection unit 12 can detect a plurality of areas satisfying such a selection condition as a target area for each user. Q is predetermined.

Another example of the selection condition in this case is “an area included in the top P in ranking in descending order of the duration in which each user has gazed at the area in a past predetermined period”. In one example, the detection unit 12 can detect a plurality of areas satisfying such a selection condition as a target area for each user. P is predetermined.

Another example of the selection condition in this case is “an area included in the top Q% in ranking in descending order of the duration in which each user has gazed at the area in a past predetermined period”. In one example, the detection unit 12 can detect a plurality of areas satisfying such a selection condition as a target area for each user. Q is predetermined.

The display unit 13 displays the presentation information in the target area detected by the detection unit 12.

The “presentation information” is information presented to the user. The presentation information may include at least one of an advertisement, a notification, event information, and game-related information. The presentation information is not limited to the example here.

“Advertisement” indicates the content of the advertisement activity of the advertisement publishing desiring user who desires to perform the advertisement activity in the virtual space. An organization such as a company may be the advertisement publishing desiring user, or an individual may be the advertisement publishing desiring user.

The advertisement includes information regarding an advertisement target. The advertisement may include letters, numbers, pictures, figures, images, sounds, and the like. The advertisement publishing desiring user can set a target that the user wants many people to know as an advertisement target.

For example, the advertisement publishing desiring user can set a product, a service, or the like sold by the user as an advertisement target. The advertisement target may be a product or a service provided in the real world or a product or a service provided in the virtual space. Examples of the product provided in the virtual space include items that can be worn or used by a character. In addition, a mode (motion, expression, etc.) in which a character can be caused to execute a product provided in the virtual space is exemplified. For example, a user who wants his/her character to have a unique mode purchases a product that can cause his/her character to execute a predetermined mode.

The advertisement target is not necessarily a sales target. For example, the advertisement publishing desiring user who wants to become famous may set himself/herself as an advertisement target. The advertisement publishing desiring user who wants to spread his/her idea may set his/her idea as an advertisement target.

The “notification” is information presented from the management side of the virtual space to the user. For example, the notification can include information regarding version upgrade of the system, information regarding system maintenance, and the like.

The “event information” is information regarding an event presented from the management side of the virtual space to the user. In one example, various events that users of the virtual space can participate in are regularly or irregularly held. The event information may include a notice of holding such an event. The event information can include, for example, date and time of the event, place of the event, content of the event, participation conditions, URL (Uniform Resource Locator) of a web page indicating details of the event, and the like.

The “game-related information” is information regarding a game presented from the management side of the virtual space to the user. In one example, various games that users of the virtual space can participate in are regularly or irregularly held. The game-related information may include such a game holding notice. The game information can include, for example, the date and time of a game, a game holding, a game content, participation conditions, a URL of a web page indicating details of the game, and the like.

The game-related information may include information presented to the user during the game. For example, the game-related information may include a game instruction, a game hint, and the like.

Next, an example of a flow of processing of the information processing device 10 will be described with reference to the flowchart of FIG. 2. The purpose here is to describe an example of the flow of processing. Since the details of each processing have been described above, the description here is appropriately omitted.

First, the information processing device 10 receives an input of presentation information and an instruction input to display the presentation information in the virtual space from a subject that presents the presentation information. The information processing device 10 can perform the processing of FIG. 2 in response to the instruction input.

In S10, the information processing device 10 acquires the line-of-sight history of the user in the virtual space.

In S11, the information processing device 10 detects, as a target area, an area in which the degree of concentration of the lines of sight of the users satisfies the selection condition based on the line-of-sight history of the user.

For example, the information processing device 10 may detect “an area in which the degree of concentration of the lines of sight of users at the current time satisfies the selection condition” as a target area. Alternatively, the information processing device 10 may detect “an area in which the degree of concentration of the lines of sight of users within a past predetermined period satisfies the selection condition” as a target area. Alternatively, the information processing device 10 may detect “an area in which the degree of concentration of the lines of sight of the users within a past predetermined period satisfies the selection condition” as a target area. Which of the plurality of types of target areas is detected may be determined in advance. For example, a subject that presents the presentation information may determine in advance which target area is to be detected and input the target area to the information processing device 10.

In S12, the information processing device 10 displays the presentation information in the target area detected in S11.

### Operations and Effects

According to the information processing device 10 of the second example embodiment, operations and effects similar to those of the information processing devices 10 of the first example embodiment can be achieved.

The information processing device 10 can display the presentation information in an area in which the degree of concentration of the lines of sight of the “users at the current time point” satisfies the selection condition. According to such an information processing device 10, it is possible to display the presentation information at a position that can be viewed by more users at the present time. As a result, the presentation information can be delivered to more users.

The information processing device 10 can display the presentation information in an area in which the degree of concentration of the lines of sight of the “users in a past predetermined period” satisfies the selection condition. According to such an information processing device 10, it is possible to display the presentation information at a position estimated to be highly likely to be viewed by more users from the tendency in a past predetermined period. As a result, the presentation information can be delivered to more users.

The information processing device 10 can display the presentation information in an area in which the degree of concentration of the lines of sight of “users within a past predetermined period” satisfies the selection condition. According to such an information processing device 10, it is possible to display the presentation information at a position estimated to be highly likely to be viewed by each user from the tendency in a past predetermined period. As a result, the presentation information can be delivered to more users.

The information processing device 10 can display “advertisement” in the target area. A higher advertising effect is expected by displaying an advertisement at a position that can be viewed by more users.

The information processing device 10 can display “notification” in the target area. By displaying the notification at a position that can be viewed by more users, it is possible to notify the user of the notice more reliably.

The information processing device 10 can display “event information” in the target area. By displaying the event information at a position that can be viewed by more users, it is possible to more reliably notify the user of the event information and cause more users to participate in the event.

The information processing device 10 can display “game-related information” in the target area. By displaying the game-related information at a position that can be viewed by more users, it is possible to more reliably notify the users of the game-related information and allow more users to participate in the game. It is possible to more reliably notify the user of important information during the progress of the game.

### Third Example Embodiment

The information processing device 10 according to a third example embodiment can detect a target area based on a degree of concentration of lines of sight on each area by “users having a predetermined attribute” and display presentation information in the detected target area. Details will be described below.

In the third example embodiment, user information indicating an attribute of each user is registered in the information processing device 10 in advance. Examples of the attribute of the user include, but are not limited to, gender, age, nationality, occupation, family structure, hobby, preference, and the like.

The detection unit 12 detects at least one of the following as a target area.
Area in which degree of concentration of the lines of sight of the “users having a predetermined attribute” at present time satisfies selection condition
Area in which degree of concentration of the lines of sight of the “users having a predetermined attribute” within past predetermined period satisfies selection condition
Area in which degree of concentration of lines of sight of “users having a predetermined attribute” in past predetermined period satisfies selection condition

Hereinafter, processing in which the detection unit 12 detects such an area will be described.

### Processing of Detecting, as a Target Area, an Area in Which Degree of Concentration of the Lines of Sight of Users Having a Predetermined Attribute at a Current Time Satisfies a Selection Condition

First, the detection unit 12 calculates a degree of concentration of the lines of sight of users having a predetermined attribute on each area at the present time.

The “degree of concentration of the lines of sight of users having a predetermined attribute on each area at the present time” indicates how many users among the users having a predetermined attribute actually gather their line of sight in each area at the present time, that is, how many users are viewing each area.

For example, the above-described acquisition unit 11 acquires the line-of-sight history of each of the plurality of users in real time, and inputs the line-of-sight history to the detection unit 12. The detection unit 12 extracts a line-of-sight history of the user having a predetermined attribute from the acquired line-of-sight history based on the user information described above. Then, based on the extracted latest line-of-sight history of each of the users having a predetermined attribute, the detection unit 12 specifies an area to which the line of sight of each of the users having a predetermined attribute is directed at the present time. Then, the detection unit 12 can calculate the number of users who have a predetermined attribute and view each of the plurality of areas in the virtual space in real time by statistically processing the result.

The “predetermined attribute” may be determined in advance. In addition, the operator may determine the predetermined attribute and input the predetermined attribute to the information processing device 10. In addition, for example, information indicating the target group of the presentation information displayed on the display unit 13 may be registered in the information processing device 10 in advance. The target group is defined using an attribute of the user. For example, the target group is “women in their 20s to 30s” or the like. Then, the detection unit 12 may adopt the attribute of the target group of the presentation information as the predetermined attribute.

An example of the selection condition in this case is “an area currently viewed by the number of users having a predetermined attribute equal to or greater than the threshold”. The threshold is a value determined in advance. In one example, the detection unit 12 can detect one or a plurality of areas satisfying such a selection condition as a target area.

Another example of the selection condition in this case is “at the present time, an area viewed by the most users having a predetermined attribute”. In one example, the detection unit 12 can detect one area satisfying such a selection condition as a target area.

Another example of the selection condition in this case is “an area ranked in the top P in ranking in descending order of the number of users having a predetermined attribute viewing at the present time”. In one example, the detection unit 12 can detect a plurality of areas satisfying such a selection condition as target areas. P is predetermined.

Another example of the selection condition in this case is “an area ranked in the top Q% in ranking in descending order of the number of users having a predetermined attribute viewing at the present time”. In one example, the detection unit 12 can detect a plurality of areas satisfying such a selection condition as target areas. Q is predetermined.

### Area in Which Degree of Concentration of the Lines of Sight of the Users Having a Predetermined Attribute Within Past Predetermined Period Satisfies Selection Condition

First, the detection unit 12 calculates a degree of concentration of the lines of sight of users having a predetermined attribute on each area in a past predetermined period.

The “degree of concentration of the lines of sight of users having a predetermined attribute on each area in a past predetermined period” indicates how many users having a predetermined attribute actually gathered their line of sight on each area, that is, how many users having a predetermined attribute viewed each area in a past predetermined period.

For example, the above-described acquisition unit 11 inputs the line-of-sight history of each of the plurality of users in a past predetermined period to the detection unit 12. The detection unit 12 extracts a line-of-sight history of the user having a predetermined attribute from the acquired line-of-sight history based on the user information described above. Then, based on the extracted line-of-sight history of each of the users having a predetermined attribute, the detection unit 12 specifies a user having a predetermined attribute who have gazed at each area in a past predetermined period, that is, a user having a predetermined attribute who has viewed each area, and counts the number of users. The detection unit 12 may perform the counting by a method in consideration of the “area at which the user is gazing” and the “area in the user's field of view” described in the second example embodiment.

In this example, the number of users having a predetermined attribute who have gazed at each area in a past predetermined period is the degree of concentration of the lines of sight of users having a predetermined attribute on each area in a past predetermined period. The past predetermined period is determined in advance. The past predetermined period may be, for example, the most recent past one year, the most recent past six months, or other periods.

The “predetermined attribute” may be determined in advance. In addition, the operator may determine the predetermined attribute and input the predetermined attribute to the information processing device 10. In addition, for example, information indicating the target group of the presentation information displayed on the display unit 13 may be registered in the information processing device 10 in advance. The target group is defined using an attribute of the user. For example, the target group is “women in their 20s to 30s” or the like. Then, the detection unit 12 may adopt the attribute of the target group of the presentation information as the predetermined attribute.

An example of the selection condition in this case is “an area in which the number of users having a predetermined attribute who have gazed at in a past predetermined period is equal to or larger than a threshold”. In one example, the detection unit 12 can detect one or a plurality of areas satisfying such a selection condition as a target area. The threshold is a value determined in advance.

Another example of the selection condition in this case is “an area having the largest number of users having a predetermined attribute who have gazed at in a past predetermined period”. In one example, the detection unit 12 can detect one area satisfying such a selection condition as a target area.

Another example of the selection condition in this case is “an area included in the top P in ranking in descending order of the number of users having a predetermined attribute who have gazed at in a past predetermined period”. In one example, the detection unit 12 can detect a plurality of areas satisfying such a selection condition as target areas. P is predetermined.

Another example of the selection condition in this case is “an area included in the top Q% in ranking in descending order of the number of users having a predetermined attribute who have gazed at in a past predetermined period”. In one example, the detection unit 12 can detect a plurality of areas satisfying such a selection condition as target areas. Q is predetermined.

### Processing of Detecting as an Area in Which a Degree of Concentration of Lines of Sight of Users Having a Predetermined Attribute in a Past Predetermined Period Satisfies a Selection Condition

For example, the above-described acquisition unit 11 inputs the line-of-sight history of each of the plurality of users in a past predetermined period to the detection unit 12. The detection unit 12 extracts a line-of-sight history of the user having a predetermined attribute from the acquired line-of-sight history based on the user information described above.

Then, the detection unit 12 processes the extracted line-of-sight history of the user having a predetermined attribute in a similar manner to the “Processing of detecting, as a target area, an area in which a degree of concentration of lines of sight of users within a past predetermined period satisfies a selection condition” described in the second example embodiment. That is, the detection unit 12 performs the “Processing of detecting, as a target area, an area in which a degree of concentration of lines of sight of users within a past predetermined period satisfies a selection condition” described in the second example embodiment by narrowing the data to be processed to the “line-of-sight history of the user having a predetermined attribute”.

The “predetermined attribute” may be determined in advance. In addition, the operator may determine the predetermined attribute and input the predetermined attribute to the information processing device 10. In addition, for example, information indicating the target group of the presentation information displayed on the display unit 13 may be registered in the information processing device 10 in advance. The target group is defined using an attribute of the user. For example, the target group is “women in their 20s to 30s” or the like. Then, the detection unit 12 may adopt the attribute of the target group of the presentation information as the predetermined attribute.

Next, an example of a flow of processing of the information processing device 10 will be described with reference to the flowchart of FIG. 2. The purpose here is to describe an example of the flow of processing. Since the details of each processing have been described above, the description here is appropriately omitted.

First, the information processing device 10 receives an input of presentation information, an input of a target group (for example, women in their 20s to 30s), and an instruction input for displaying the presentation information in the virtual space from a subject that presents the presentation information. The information processing device 10 can perform the processing of FIG. 2 in response to the instruction input.

In S10, the information processing device 10 acquires the line-of-sight history of the user in the virtual space.

In S11, the information processing device 10 detects, as a target area, an area in which the degree of concentration of the lines of sight of the users satisfies the selection condition based on the line-of-sight history of the user.

For example, the information processing device 10 may detect “an area in which the degree of concentration of the lines of sight of users having a predetermined attribute at the current time satisfies the selection condition” as a target area. Alternatively, the information processing device 10 may detect “an area in which the degree of concentration of the lines of sight of users having a predetermined attribute within a past predetermined period satisfies the selection condition” as a target area. Alternatively, the information processing device 10 may detect “an area in which the degree of concentration of the lines of sight of the users having a predetermined attribute within a past predetermined period satisfies the selection condition” as a target area. Which of the plurality of types of target areas is detected may be determined in advance. For example, a subject that presents the presentation information may determine in advance which target area is to be detected and input the target area to the information processing device 10.

The “predetermined attribute” may be determined in advance. In addition, the operator may determine a predetermined attribute and input the predetermined attribute to the information processing device 10. In addition, the attribute of the target group (for example, women in their 20s to 30s) input by the subject that presents the presentation information may be used as the predetermined attribute.

In S12, the information processing device 10 displays the presentation information in the target area detected in S11.

Other configurations of the information processing device 10 can be similar to those of the first and second example embodiments.

According to the information processing device 10 of the third example embodiment, operations and effects similar to those of the information processing devices 10 of the first and second example embodiments can be achieved. The information processing device 10 can detect a target area based on “a degree of concentration of lines of sight on each area by users having a predetermined attribute” and display presentation information in the detected target area.

For example, in a case where the presentation information (advertisement or the like) for a predetermined target group is displayed, the information processing device 10 can detect the target area based on the degree of concentration of the lines of sight to each area by the users of the target group. That is, the information processing device 10 can detect an area frequently viewed by the user of the target group as a target area. Then, the information processing device 10 can display the presentation information in the target area detected in this manner.

According to such an information processing device 10, it is possible to display presentation information (advertisement or the like) for a predetermined target group in an area frequently viewed by the users of the target group. As a result, the presentation information can be efficiently conveyed to the users of the target group.

### Fourth Example Embodiment

Even in an area where the line of sight of the user is concentrated, it may be undesirable to display the presentation information. For example, in a case where there is an ornamental object in an area where the line of sight of the user is concentrated, It is undesirable to display the presentation information in the area because the ornamental object becomes difficult to see. Therefore, the information processing device 10 according to the fourth example embodiment determines whether it is possible to display the presentation information in an area in which the degree of concentration of the lines of sight of the users satisfies the selection condition. Then, the information processing device 10 detects the area determined to be displayable as a target area. According to such an information processing device 10, it is possible to display the presentation information in the area determined to be displayable among the areas in which the degree of concentration of the lines of sight of the users satisfies the selection condition. Details will be described below.

First, based on the line-of-sight history of the user, the detection unit 12 detects an area in which the degree of concentration of the lines of sight of the users satisfies the selection condition. The processing is as described in the second and third example embodiments.

Next, the detection unit 12 determines whether display availability of the presentation information in the area where the degree of concentration of the lines of sight of the users satisfies the selection condition based on a predetermined rule. Then, the detection unit 12 detects, as a target area, an area determined to be capable of displaying the presentation information in the area in which the degree of concentration of the lines of sight of the users satisfies the selection condition.

In the rule, a rule for determining that the presentation information can be displayed may be defined. In addition, the rule may define a rule for determining that the presentation information cannot be displayed. Hereinafter, an example of the rule will be described, but the rule is not limited thereto.

In one example of the rule, it may be defined that the presentation information cannot be displayed in the area where the specific object exists. The specific object is an object present therein for the purpose of being seen by the user, and examples thereof include, but are not limited to, ornamental object (works of art, ornamental plants, etc.), posters, and the like.

In a case where a specific object as described above exists in an area where the degree of concentration of the lines of sight of the users satisfies the selection condition, it is considered that the line of sight of the user is concentrated in the area because the user is looking at the specific object. It is undesirable to display the presentation information in such an area because it hinders viewing of the specific object.

In the case of this example, a list of objects installed in the virtual space may be generated in advance and stored in the information processing device 10. In the list, an installation position and an object type (ornamental objects, posters, etc.) are indicated in association with each object installed in the virtual space. The detection unit 12 can determine whether a specific object, that is, an object of a specific object type exists in an area where the degree of concentration of the lines of sight of the users satisfies the selection condition based on the list of objects.

In another example of the rule, it may be defined that display of presentation information in an area where an object observed from a specific direction is present is prohibited. Then, it may be defined that the presentation information can be displayed in the area where the object observed from a plurality of directions exists. Examples of the object observed from a specific direction include, but are not limited to, an object indicating two-dimensional information (image or the like) such as a poster. Examples of the object observed from a plurality of directions include, but are not limited to, a three-dimensional object such as an ornamental plant.

In a case where there is an object observed from a specific direction in an area where the degree of concentration of the lines of sight of the users satisfies the selection condition, it is considered that the line of sight of the user is concentrated in the area because the user is looking at the object. It is undesirable to display the presentation information in such an area because it hinders the observation of the object.

On the other hand, in a case where there is an object observed from a plurality of directions in an area where the degree of concentration of the lines of sight of the users satisfies the selection condition, since the user is looking at the object observed from the plurality of directions, it is considered that the line of sight of the user is concentrated in the area. Displaying the presentation information in such an area may hinder the observation of the object from a certain direction among the plurality of directions. However, the object can be observed from other directions among the plurality of directions. Therefore, in a case where there is an object observed from a plurality of directions in an area where the degree of concentration of the lines of sight of the users satisfies the selection condition, it is considered that the presentation information may be displayed in the area.

In a case where the presentation information is displayed in an area where an object observed from a plurality of directions exists, the display unit 13 can display the presentation information around the object so as not to overlap the object. In this case, in a case where the presentation information is observed from a direction in which the presentation information comes in front of the object (observer side), the presentation information prevents the observation of the object. However, in a case where the object is observed from other directions, the presentation information does not come in front of the object, and the presentation information does not prevent the observation of the object.

In the case of this example, a list of objects installed in the virtual space may be generated in advance and stored in the information processing device 10. In the list, the installation position and the object characteristic (object observed from a predetermined direction, object observed from a plurality of directions, and the like) are indicated in association with each object installed in the virtual space. Based on the list of the objects, the detection unit 12 can determine what kind of characteristic the object exists in the area where the degree of concentration of the lines of sight of the users satisfies the selection condition.

Other configurations of the information processing device 10 can be similar to those of the first to third example embodiments.

According to the information processing device 10 of the fourth example embodiment, operations and effects similar to those of the information processing devices 10 of the first to third example embodiments can be achieved. Even in an area where the line of sight of the user is concentrated, it may be undesirable to display the presentation information. For example, in a case where there is an ornamental object in an area where the line of sight of the user is concentrated, It is undesirable to display the presentation information in the area because the ornamental object becomes difficult to see.

Therefore, the information processing device 10 according to the fourth example embodiment determines whether it is possible to display the presentation information in an area in which the degree of concentration of the lines of sight of the users satisfies the selection condition. Then, the information processing device 10 detects the area determined to be displayable as a target area. According to such an information processing device 10, it is possible to display the presentation information in the area determined to be displayable among the areas in which the degree of concentration of the lines of sight of the users satisfies the selection condition. As a result, it is possible to suppress inconvenience such as difficulty in viewing the ornamental object existing in the area due to display in the presentation information.

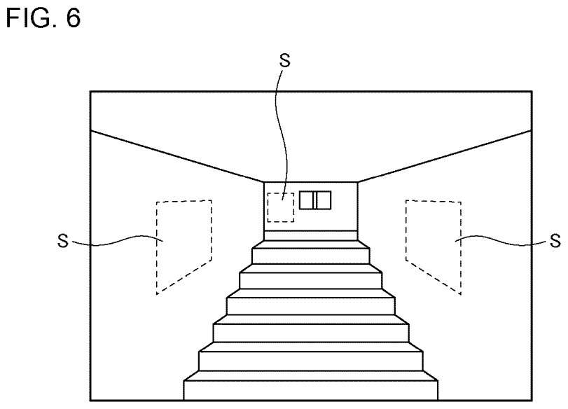

According to such an information processing device 10, for example, it is possible to detect, as a target area, an area or the like in which an object such as an ornamental object does not exist but the line of sight of the user is well concentrated. For example, in a passage such as a staircase or a corridor, the line of sight of the user traveling through the passage may gather in an empty predetermined area. For example, in a case where there is a passage (staircase) as illustrated in FIG. 6 in the virtual space, the line of sight of the user traveling through the passage may gather in a part of a wall in front of the passage or a part of a side wall. For example, the information processing device 10 can detect, as a target area S, an area in which there is no object such as an ornamental object but the line of sight of the user is well concentrated. Then, the information processing device 10 can display the presentation information in such a target area S.

According to such an information processing device 10, it is possible to display the presentation information in the area where the line of sight of the user gathers without impairing the visibility of the existing ornamental object or the like.

### Fifth Example Embodiment

The information processing device 10 of the fifth example embodiment can determine the amount of money to be paid as a consideration for displaying the presentation information in the target area based on the degree of concentration of the lines of sight of the users in the target area. Details will be described below.

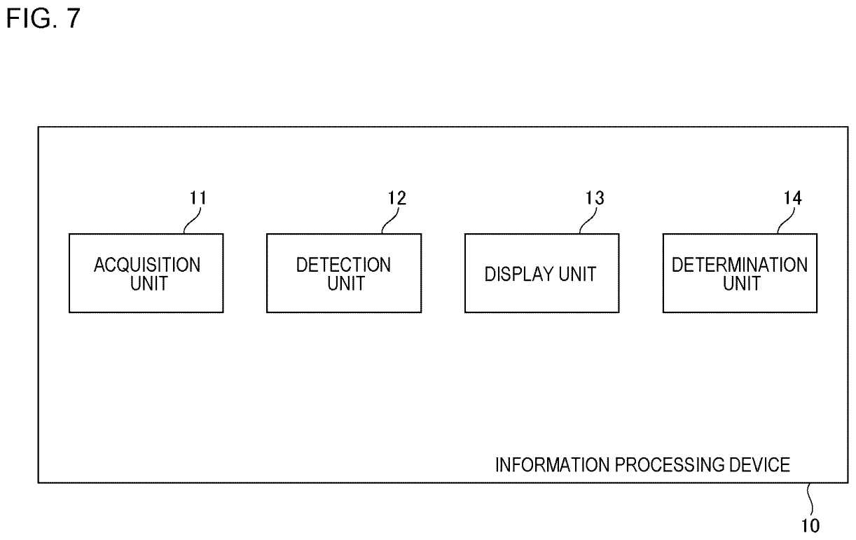

FIG. 7 illustrates an example of a functional block diagram of the information processing device 10. As illustrated, the information processing device 10 includes an acquisition unit 11, a detection unit 12, a display unit 13, and a determination unit 14.

The determination unit 14 determines an amount of money to be paid as a consideration for displaying the presentation information in the target area based on the degree of concentration of the lines of sight of the users in the target area.

The presentation information is, for example, an advertisement. Then, a consideration for displaying the presentation information (advertisement) is an advertisement fee. Such a consideration is paid, for example, from the advertisement publishing desiring user to the operating side of the virtual space.

The determination unit 14 can determine a higher consideration (amount of money) for a target area having a higher degree of concentration of the lines of sight of the users. In one example, a consideration calculation model in which the degree of concentration of the lines of sight of the users is input and the consideration is output is generated in advance and stored in the information processing device 10. The consideration calculation model may be configured by an arithmetic expression or may be configured by a table indicating a relationship between the degree of concentration of the lines of sight of the users and the consideration. For example, the determination unit 14 inputs the degree of concentration of the lines of sight of the users in each target area to such a consideration calculation model, and acquires the consideration output from the consideration calculation model.

In one example, after actually displaying the presentation information, the determination unit 14 can calculate the consideration based on the actual value of the degree of concentration of the lines of sight of the users on the target area in the implementation period in which the presentation information has been displayed.

For example, the determination unit 14 obtains the degree of concentration of the lines of sight of the users on the target area at each of the plurality of sampling timings in the implementation period (for example, the number of users who are looking at the target area). The sampling timing is, for example, timing at predetermined time intervals, but is not limited thereto. Then, the determination unit 14 obtains a statistical value of the degree of concentration of the lines of sight of the users on the target area at each of the plurality of sampling timings as the actual value. The statistical value is an average value, a maximum value, a minimum value, a mode value, a median value, or the like, but is not limited thereto. Then, the determination unit 14 inputs the actual value to the consideration calculation model and acquires the consideration output from the consideration calculation model.

In another example, before actually displaying the presentation information, the determination unit 14 can calculate the consideration based on the past actual value of the degree of concentration of the lines of sight of the users on the target area in which the presentation information is displayed.

For example, the determination unit 14 obtains a degree of concentration of the lines of sight of the users to the target area at each of a plurality of sampling timings in a predetermined reference period before the presentation information is actually displayed (for example, the number of users viewing the target area). The sampling timing is, for example, timing at predetermined time intervals, but is not limited thereto. Then, the determination unit 14 obtains a statistical value of the degree of concentration of the lines of sight of the users on the target area at each of the plurality of sampling timings as the actual value. The statistical value is an average value, a maximum value, a minimum value, a mode value, a median value, or the like, but is not limited thereto. Then, the determination unit 14 inputs the actual value to the consideration calculation model and acquires the consideration output from the consideration calculation model.

According to this example, before actually displaying the presentation information, the consideration can be determined based on the past results of the degree of concentration of the lines of sight of the users. According to this example, before actually displaying the presentation information, it is possible to calculate a rough indication of the consideration based on past results of the degree of concentration of the lines of sight of the users.

In another example, the determination unit 14 can calculate the consideration based on the actual value of the degree of concentration of the lines of sight of the users on the target area displaying the presentation information at the present time.

For example, the determination unit 14 acquires the degree of concentration of the lines of sight of the users on the target area at the present time (for example, the number of users who are looking at the target area). Then, the determination unit 14 inputs the acquired degree of concentration of the lines of sight of the users to the consideration calculation model, and acquires a consideration output from the consideration calculation model.

According to this example, it is possible to determine the real-time consideration calculated from the result of the degree of concentration of the lines of sight of the users at the present time.

The determination unit 14 can store the determined consideration in a predetermined storage device. The determination unit 14 may output the determined consideration. For example, the determination unit 14 may display the determined consideration on the terminal device of the user.

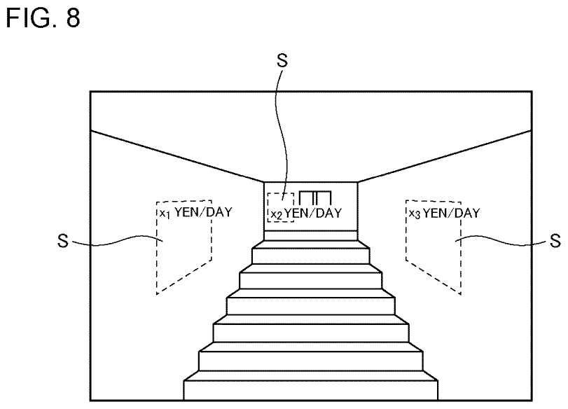

Here, an example of a user interface (UI) screen output by the information processing device 10 will be described. The advertisement publishing desiring user can call an advertisement publishing examination screen and display the screen on his/her terminal device. On the advertisement publishing examination screen, a part of the virtual space is displayed as illustrated in FIG. 8. The advertisement publishing desiring user can change a part of the virtual space displayed on the advertisement publishing examination screen by an arbitrary operation.

As illustrated in FIG. 8, the target area S detected by the detection unit 12 is displayed on the advertisement publishing examination screen in an identifiable manner. In the drawing, the target area S is indicated by a dotted frame. The target area S is an area where the line of sight of the user frequently gathers. Such a target area S is a candidate for an area in which an advertisement is presented.

As illustrated in FIG. 8, on the advertisement publishing examination screen, the consideration determined by the determination unit 14 is displayed in association with each target area S. In the example of FIG. 8, the consideration per day is displayed, but the display method is not limited thereto. The advertisement publishing desiring user can examine an area where the advertisement is posted through such an advertisement publishing examination screen. The advertisement publishing examination screen illustrated in FIG. 8 may receive an input for selecting an area in which an advertisement is displayed from among the plurality of target areas S being displayed from the advertisement publishing desiring user.

The real-time consideration calculated from the results of the degree of concentration of the lines of sight of the users at the present time may be displayed on the advertisement publishing examination screen as illustrated in FIG. 8. In this case, the determination unit 14 may repeatedly determine the consideration based on the latest “degree of concentration of the lines of sight of the users in the target area”. Then, on the advertisement publishing examination screen illustrated in FIG. 8, the consideration displayed in association with each target area S may be updated in real time.

Other configurations of the information processing device 10 can be similar to those of the first to fourth example embodiments.

According to the information processing device 10 of the fifth example embodiment, operations and effects similar to those of the information processing devices 10 of the first to fourth example embodiments can be achieved. The information processing device 10 can determine the amount of money to be paid as a consideration for displaying the presentation information in the target area based on the degree of concentration of the lines of sight of the users in the target area. According to such an information processing device 10, it is possible to determine an appropriate amount of money as a consideration for displaying the presentation information in the target area.

The information processing device 10 rationally specifies in which area an advertisement is effectively displayed based on the line-of-sight history of the user, and sets an appropriate consideration (unit price for advertisement) based on the degree of concentration of the lines of sight of the users. According to such an information processing device 10, it is possible to maximize cost-effectiveness of advertisement display. The advertisement publishing desiring user can implement efficient advertisement arrangement, and can obtain a high cost-effectiveness commensurate with advertisement rates.

### Sixth Example Embodiment

The information processing device 10 according to a sixth example embodiment can analyze a correlation between a degree of concentration of lines of sight of users in a target area and an action detected after presentation information is displayed in the target area. Details will be described below.

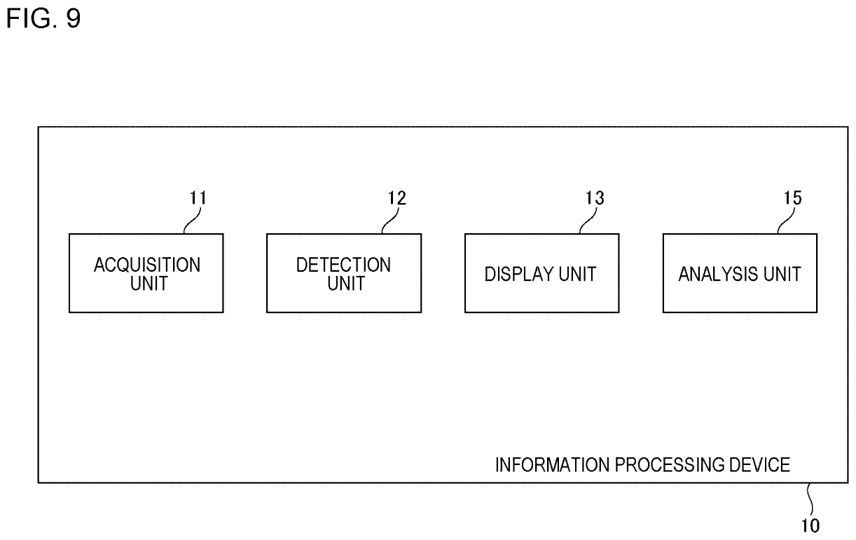

FIG. 9 illustrates an example of a functional block diagram of the information processing device 10. As illustrated, the information processing device 10 includes an acquisition unit 11, a detection unit 12, a display unit 13, and an analysis unit 15. The information processing device 10 may include the determination unit 14.

The analysis unit 15 analyzes a correlation between a degree of concentration of lines of sight of the users in the target area and an action detected after the presentation information is displayed in the target area.

The “action detected after the presentation information is displayed in the target area” is an action executed by the user who has viewed the presentation information.

The above action may be, for example, purchase of an advertisement target (product or service) advertised in an advertisement (presentation information). In this example, the analysis unit 15 acquires the sales data of the advertisement target in a predetermined period after the advertisement is displayed in the target area. The analysis unit 15 can acquire the sales data of each of the plurality of advertisement targets in which the advertisement is displayed in each of the plurality of target areas. The sales data indicates the number of sales and the sales amount in a predetermined period. The analysis unit 15 may receive an input of sales data from the advertisement publishing desiring user.

Then, the analysis unit 15 calculates a correlation (correlation coefficient) between the data based on the degree of concentration of the lines of sight of the users in each of the plurality of target areas and the sales data of the advertisement target in which the advertisement is displayed in each of the plurality of target areas.

In another example, the action may be accessing a related web page of an advertisement target (product or service) advertised in, for example, an advertisement (presentation information). The related web page may be an introduction page of a product or a service by a manufacturer of the product or the service, or may be a sales page of the product or the service in a shopping site.

In this example, the analysis unit 15 acquires the access frequency to the related web page of the advertisement target in a predetermined period after the advertisement is displayed in the target area. The analysis unit 15 can acquire the access frequency to the related web page of each of the plurality of advertisement targets displaying the advertisement in each of the plurality of target areas. The analysis unit 15 may receive an input of the access frequency from the advertisement publishing desiring user, or may calculate the access frequency to the target web page using a predetermined analysis tool.

Then, the analysis unit 15 calculates a correlation (correlation coefficient) between the data based on the degree of concentration of the lines of sight of the users in each of the plurality of target areas and the access frequency to the related web page of the advertisement target in which the advertisement is displayed in each of the plurality of target areas.

In another example, the action may be, for example, referring to an advertisement target (product or service) advertised in an advertisement (presentation information) on a predetermined social networking service (SNS).

In this example, the analysis unit 15 acquires the number of times (reference frequency) that the advertisement target is mentioned on the predetermined SNS in the predetermined period after the advertisement is displayed in the target area. The analysis unit 15 can acquire the reference frequency of each of the plurality of advertisement targets displaying the advertisement in each of the plurality of target areas. The analysis unit 15 may receive an input of the reference frequency from the advertisement publishing desiring user, or may acquire the reference frequency published on a predetermined website.

Then, the analysis unit 15 calculates a correlation (correlation coefficient) between the data based on the degree of concentration of the lines of sight of the users in each of the plurality of target areas and the reference frequency on the SNS of the advertisement target in which the advertisement is displayed in each of the plurality of target areas.

Here, modifications will be described. The analysis unit 15 may group users based on attributes of the users. Then, the analysis unit 15 may obtain the correlation for each group based on the action by the user of each group and the degree of concentration of the lines of sight of the users of each group in the target area.

The analysis unit 15 may group the target areas based on the characteristics of the target areas. For example, the analysis unit 15 may group the target areas based on position characteristics (outdoor, indoor, height from ground, etc.) of the target areas. Then, for each group, the analysis unit 15 may obtain a correlation between the degree of concentration of the lines of sight of the users in the target area belonging to each group and the action detected after the presentation information is displayed in the target area.

The analysis unit 15 may generate a prediction model that estimates the result of the action (sales, access frequency, reference frequency, etc.) from the degree of concentration of the lines of sight of the users based on the calculated correlation.

Other configurations of the information processing device 10 can be similar to those of the first to fifth example embodiments.

According to the information processing device 10 of the sixth example embodiment, operations and effects similar to those of the information processing devices 10 of the first to fifth example embodiments can be achieved. The information processing device 10 can analyze a correlation between a degree of concentration of lines of sight of users in a target area and an action detected after presentation information is displayed in the target area. The action detected after the presentation information is displayed in the target area is an action executed by the user who has viewed the presentation information. In a case where the presentation information is an advertisement, by analyzing the correlation between such an action and the degree of concentration of the lines of sight of the users in the target area, the correlation between the degree of concentration of the lines of sight of the users in the target area and the advertising effect can be obtained. By using the analysis result, it is possible to display an advertisement in a target area having a higher advertising effect.

The information processing device 10 can group based on the attribute of the user, the characteristic of the target area, and the like, and obtain the correlation for each group. According to such an information processing device 10, more detailed analysis may be desirable.

### Seventh Example Embodiment

The information processing device 10 of a seventh example embodiment can customize the content of the presentation information for each user. Details will be described below.

The display unit 13 specifies a target in which each user indicates an interest based on the line-of-sight history of each user. Then, the display unit 13 displays the presentation information (advertisement or the like) related to the specified target in the target area.

For example, the display unit 13 may estimate the preference of each user based on the line-of-sight history of each user. Then, the display unit 13 may display the presentation information matching the user's preference in the target area. The estimation of the user's preference based on the line-of-sight history of the user can be implemented using widely known technologies. For example, the display unit 13 may specify an object viewed by the user based on the line-of-sight history of the user. In addition, the display unit 13 may specify an object that the user has viewed for a predetermined time or more, an object that the user has viewed a predetermined number of times or more, or the like based on the line-of-sight history of the user. Then, the display unit 13 may estimate the preference of the user based on the specific result. For example, the display unit 13 may specify the specified object as the user's personal preference item. In addition, the display unit 13 may specify an attribute common to the specified objects as the preference of the user.

A plurality of types of presentation information are stored in advance in the information processing device 10 in association with the preference of each piece of presentation information. The display unit 13 can extract the presentation information associated with the preference of each user and display the presentation information in the target area.

In this example, the detection unit 12 may detect, as a target area, an area in which the degree of concentration of the lines of sight of the users within a past predetermined period satisfies the selection condition. Then, the display unit 13 may display the presentation information matching the preference of each user in the target area detected for each user.

In addition, the detection unit 12 may specify an area currently viewed by each user as a target area based on the line-of-sight history information. Then, the display unit 13 may display the presentation information matching the preference of each user in the target area detected for each user.

Other configurations of the information processing device 10 can be similar to those of the first to sixth example embodiments.

According to the information processing device 10 of the seventh example embodiment, operations and effects similar to those of the information processing devices 10 of the first to sixth example embodiments can be achieved. The information processing device 10 can display an advertisement (presentation information) suitable for each user to each user. According to such an information processing device 10, a high advertising effect is expected.

### MODIFICATION EXAMPLE

Hereinafter, modification examples applicable to the first to seventh example embodiments will be described.

### First Modified Example

In the first modification, a virtual tour is provided in a virtual space. The virtual tour is a tour performed in a virtual space. The virtual tour may be a space trip or the like, or may be something else. The user can participate in the virtual tour and have a tour experience in the virtual space.

The information processing device 10 acquires a line-of-sight history during the virtual tour of the user participating in the virtual tour. Then, the information processing device 10 analyzes the line-of-sight history and specifies a target in which each user is interested among tourist spots visited during the virtual tour. For example, the information processing device 10 specifies a target present in an area where the degree of concentration of the lines of sight of the users during the virtual tour is equal to or greater than the reference value. Here, the degree of concentration of the lines of sight of the users is at least one of the number of times of viewing each area, the cumulative time of viewing each area, and the duration of time of continuously looking at each area.

Then, the information processing device 10 displays presentation information regarding a target in which each user is interested in the target area for each user during the virtual tour or after the virtual tour.

In this example, the information processing device 10 may display the presentation information regarding the target in which each user is interested in the target area detected for each user based on the line-of-sight history of each user.

In addition, the detection unit 12 may specify an area currently viewed by each user as a target area based on the line-of-sight history information. Then, the display unit 13 may display the presentation information regarding the target in which each user is interested in the target area currently viewed by each user.

### Second Modified Example

The degree of concentration of the lines of sight of the users may change from moment to moment. As a result, an area (target area) in which the degree of concentration of the lines of sight of the users satisfies the selection condition may change from moment to moment.

The information processing device 10 can dynamically change the display position of the presentation information following such a change in the target area.

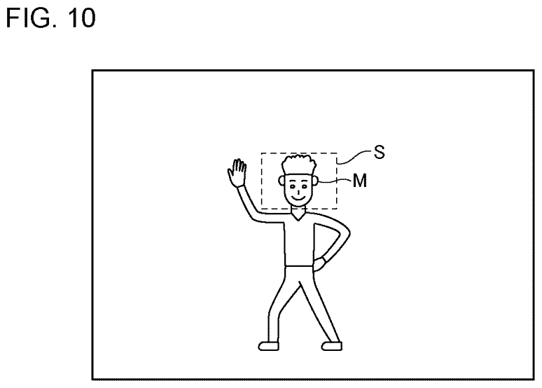

For example, in a case where a celebrity M exists in the virtual space as illustrated in FIG. 10, the lines of sight of a plurality of users are concentrated on the celebrity M, and a place where the celebrity M exists is detected as the target area S. Then, the detected target area S also moves following the movement of the celebrity M.

The information processing device 10 can dynamically change the display position of the presentation information following such a change in the target area S. In a case where a place where a person is present is detected as the target area S as in the example, the information processing device 10 may display the presentation information around the target area S (for example, above the target area S).

In the case of this example, the user (hereinafter, a famous user) who operates the celebrity M may select whether to permit or reject the display of the presentation information around the celebrity M, and may input the result to the information processing device 10. Then, the famous user who has permitted the display of the presentation information around the celebrity M may receive a reward for displaying the presentation information around the celebrity M from the operation side of the virtual space.

The information processing device 10 can calculate a reward according to the degree of concentration of the lines of sight of the users and pay the reward to the famous user. The information processing device 10 determines to pay more reward to the famous user who operates the celebrity M who has gathered the lines of sight of more users. In one example, a reward calculation model in which the degree of concentration of the lines of sight of the users is input and the reward is output is generated in advance and stored in the information processing device 10. The reward calculation model may be configured by an arithmetic expression or may be configured by a table indicating a relationship between the degree of concentration of the lines of sight of the users and the reward. For example, the information processing device 10 inputs the degree of concentration of the lines of sight of the users on the celebrity M to such a reward calculation model, and acquires a reward output from the reward calculation model.

The information processing device 10 may determine whether the famous user is a nuisance influencer using artificial intelligence (AI). Nuisance influencers are people who become famous due to unfavourable behavior. For example, correct answer data of nuisance influencers is prepared based on a past notification history in the metaverse space. The notification history includes notification target information. For example, the notification history includes action as a notification target, behavior as a notification target, attribute information of the user as a notification target, profile information of the user as a notification target, and the like. Then, the correct answer data is used as training data, and a learning model for determining whether the user is a nuisance influencer is generated. The information processing device 10 can input information of a famous user (action, behavior, attribute information, profile information, and the like) to the learning model and acquire a determination result (whether the user is a nuisance influencer) output from the learning model. Then, the information processing device 10 may be configured not to pay a reward to a famous user determined to be a nuisance influencer. The information processing device 10 may determine not to display the presentation information around the character operated by the famous user determined as the nuisance influencer.

The AI is implemented by, for example, a neural network. The neural network includes a plurality of artificial neurons and has synapses connecting the neurons. Each synapse has a weight. In a case where an input is received, such a neural network performs calculation using a weight associated with each synapse, and performs output according to the input. The model representing the connection relationship between the neuron and the synapse is stored in the memory in the form of software, for example. Alternatively, the model may be implemented as a dedicated circuit. Similarly, the weight of each synapse is also stored in the memory in the form of software. A circuit representing a weight may be mounted in a dedicated circuit. In a case where the AI is configured using a plurality of models, not all the models are necessarily stored in the same memory. There are various models using such a neural network. The generative AI may be implemented by adopting and replacing various models such as a Transformer, a convolutional neural network (CNN), and a recurrent neural network (RNN).

### Third Modified Example

The information processing device 10 includes a line-of-sight tracking device that acquires a line-of-sight history of the user and a processor that calculates a degree of concentration (line-of-sight density) of the lines of sight based on the acquired information. The processor detects an area having a high degree of concentration of the lines of sight as a target area, and communicates with a device that dynamically arranges an advertisement in real time with respect to the detected target area. The device can calculate and output a consideration for displaying the advertisement in the target area based on the degree of concentration of the lines of sight and the determination result of the display availability of the advertisement can be displayed.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the flowchart used in the descriptions above, a plurality of steps (processes) is described in order. However, an execution order of the steps executed in each example embodiment is not limited to the described order. In each example embodiment, the order of the illustrated steps can be changed as long as nothing interferes in terms of content.

Some or all of the above example embodiments may be described as the following Supplementary Notes, but are not limited to the following.
1. An information processing device including:
an acquisition means for acquiring a line-of-sight history of a user in a virtual space;
a detection means for detecting, as a target area, an area in which a degree of concentration of lines of sight of users satisfies a selection condition based on the line-of-sight history; and
a display means for displaying presentation information in the target area.
2. The information processing device according to 1, in which
the detection means is configured to execute:
determining display availability of the presentation information in an area satisfying the selection condition based on a predetermined rule; and
detecting, as the target area, an area determined to be capable of displaying the presentation information among areas satisfying the selection condition.
3. The information processing device according to 1 or 2, further including a determination means for determining an amount of money to be paid as a consideration for displaying the presentation information in the target area based on a degree of concentration of lines of sight of the users in the target area.
4. The information processing device according to any one of 1 to 3, in which
the detection means is configured to execute detecting, as the target area, at least one of:
an area in which a degree of concentration of lines of sight of users at a present point satisfies the selection condition;
an area in which a degree of concentration of lines of sight of users within a past predetermined period satisfies the selection condition; and
an area in which a degree of concentration of lines of sight of users within a past predetermined period satisfies the selection condition.
5. The information processing device according to any one of 1 to 4, in which
the detection means is configured to execute detecting, as the target area, at least one of:
an area in which a degree of concentration of lines of sight of users having a predetermined attribute at a present point satisfies the selection condition;
an area in which a degree of concentration of lines of sight of users having a predetermined attribute within a past predetermined period satisfies the selection condition; and
an area in which a degree of concentration of lines of sight of users having a predetermined attribute within a past predetermined period satisfies the selection condition.
6. The information processing device according to any one of 1 to 5, further including an analysis means for analyzing a correlation between a degree of concentration of lines of sight of users in the target area and an action detected after the presentation information is displayed in the target area.
7. The information processing device according to any one of 1 to 6, in which
the display means is configured to execute:
specifying a target in which a user shows an interest based on the line-of-sight history, and displaying the presentation information related to the specified target in the target area.
8. The information processing device according to any one of 1 to 7, in which the display means displays the presentation information, which is at least one of an advertisement, a notification, event information, and game-related information, in the target area.
9. An information processing method for causing one or more computers to execute:
acquiring a line-of-sight history of a user in a virtual space;
detecting, as a target area, an area in which a degree of concentration of lines of sight of users satisfies a selection condition based on the line-of-sight history; and
displaying presentation information in the target area.
10. A program for causing a computer to execute processing including:
acquiring a line-of-sight history of a user in a virtual space;
detecting, as a target area, an area in which a degree of concentration of lines of sight of users satisfies a selection condition based on the line-of-sight history; and
displaying presentation information in the target area.

Some or all of Supplementary Notes 2 to 8 dependent on the information processing device of Supplementary Note 1 described above can also be dependent on the information processing method of Supplementary Note 9 and the program of Supplementary Note 10 by dependency relationship similar to Supplementary Note 1 and Supplementary Notes 2 to 8. Furthermore, a part or all of the configuration described as a supplementary note can be achieved in various pieces of hardware and software, and various recording means for recording software, or systems without departing from the above-described example embodiments.

1. An information processing apparatus comprising:
at least one memory configured to store one or more instructions; and
at least one processor configured to execute the one or more instructions to:
acquire a line-of-sight history of a user in a virtual space;
detect, as a target area, an area in which a degree of concentration of lines of sight of users satisfies a selection condition based on the line-of-sight history; and
display presentation information in the target area.

2. The information processing apparatus according to claim 1, wherein
the at least one processor is further configured to execute the one or more instructions to
determine display availability of the presentation information in an area satisfying the selection condition based on a predetermined rule, and
detect, as the target area, an area determined to be capable of displaying the presentation information among areas satisfying the selection condition.

3. The information processing apparatus according to claim 1, wherein the at least one processor is further configured to execute the one or more instructions to determine an amount of money to be paid as a consideration for displaying the presentation information in the target area based on a degree of concentration of lines of sight of the users in the target area.

4. The information processing apparatus according to claim 1, wherein
the at least one processor is further configured to execute the one or more instructions to detect, as the target area, at least one of:
an area in which a degree of concentration of lines of sight of users at a present point satisfies the selection condition;
an area in which a degree of concentration of lines of sight of users within a past predetermined period satisfies the selection condition; and
an area in which a degree of concentration of lines of sight of users within a past predetermined period satisfies the selection condition.

5. The information processing apparatus according to claim 1, wherein
the at least one processor is further configured to execute the one or more instructions to detect, as the target area, at least one of:
an area in which a degree of concentration of lines of sight of users having a predetermined attribute at a present point satisfies the selection condition;
an area in which a degree of concentration of lines of sight of users having a predetermined attribute within a past predetermined period satisfies the selection condition; and
an area in which a degree of concentration of lines of sight of users having a predetermined attribute within a past predetermined period satisfies the selection condition.

6. The information processing apparatus according to claim 1, wherein the at least one processor is further configured to execute the one or more instructions to analyze a correlation between a degree of concentration of lines of sight of users in the target area and an action detected after the presentation information is displayed in the target area.

7. The information processing apparatus according to claim 1, wherein
the at least one processor is further configured to execute the one or more instructions to specify a target in which a user shows an interest based on the line-of-sight history, and display the presentation information related to the specified target in the target area.

8. The information processing apparatus according to claim 1, wherein the at least one processor is further configured to execute the one or more instructions to display the presentation information, which is at least one of an advertisement, a notification, event information, and game-related information, in the target area.

9. An information processing method for causing one or more computers to execute:
acquiring a line-of-sight history of a user in a virtual space;
detecting, as a target area, an area in which a degree of concentration of lines of sight of users satisfies a selection condition based on the line-of-sight history; and
displaying presentation information in the target area.

10. The information processing method according to claim 9, wherein
the one or more computers
determine display availability of the presentation information in an area satisfying the selection condition based on a predetermined rule, and
detect, as the target area, an area determined to be capable of displaying the presentation information among areas satisfying the selection condition.

11. The information processing method according to claim 9, wherein the one or more computers determine an amount of money to be paid as a consideration for displaying the presentation information in the target area based on a degree of concentration of lines of sight of the users in the target area.

12. The information processing method according to claim 9, wherein
the one or more computers detect, as the target area, at least one of:
an area in which a degree of concentration of lines of sight of users at a present point satisfies the selection condition;
an area in which a degree of concentration of lines of sight of users within a past predetermined period satisfies the selection condition; and
an area in which a degree of concentration of lines of sight of users within a past predetermined period satisfies the selection condition.

13. The information processing method according to claim 9, wherein
the one or more computers detect, as the target area, at least one of:
an area in which a degree of concentration of lines of sight of users having a predetermined attribute at a present point satisfies the selection condition;
an area in which a degree of concentration of lines of sight of users having a predetermined attribute within a past predetermined period satisfies the selection condition; and
an area in which a degree of concentration of lines of sight of users having a predetermined attribute within a past predetermined period satisfies the selection condition.

14. The information processing method according to claim 9, wherein the one or more computers analyze a correlation between a degree of concentration of lines of sight of users in the target area and an action detected after the presentation information is displayed in the target area.

15. A non-transitory computer-readable medium storing a program for causing a computer to:
acquire a line-of-sight history of a user in a virtual space;
detect, as a target area, an area in which a degree of concentration of lines of sight of users satisfies a selection condition based on the line-of-sight history; and
display presentation information in the target area.

16. The non-transitory computer-readable medium according to claim 15, wherein
the program causes the computer to
determine display availability of the presentation information in an area satisfying the selection condition based on a predetermined rule, and
detect, as the target area, an area determined to be capable of displaying the presentation information among areas satisfying the selection condition.

17. The non-transitory computer-readable medium according to claim 15, wherein the program causes the computer to determine an amount of money to be paid as a consideration for displaying the presentation information in the target area based on a degree of concentration of lines of sight of the users in the target area.

18. The non-transitory computer-readable medium according to claim 15, wherein
the program causes the computer to detect, as the target area, at least one of:
an area in which a degree of concentration of lines of sight of users at a present point satisfies the selection condition;
an area in which a degree of concentration of lines of sight of users within a past predetermined period satisfies the selection condition; and
an area in which a degree of concentration of lines of sight of users within a past predetermined period satisfies the selection condition.

19. The non-transitory computer-readable medium according to claim 15, wherein
the program causes the computer to detect, as the target area, at least one of:
an area in which a degree of concentration of lines of sight of users having a predetermined attribute at a present point satisfies the selection condition;
an area in which a degree of concentration of lines of sight of users having a predetermined attribute within a past predetermined period satisfies the selection condition; and
an area in which a degree of concentration of lines of sight of users having a predetermined attribute within a past predetermined period satisfies the selection condition.

20. The non-transitory computer-readable medium according to claim 15, wherein the program causes the computer to analyze a correlation between a degree of concentration of lines of sight of users in the target area and an action detected after the presentation information is displayed in the target area.
